(19) United States
(12) Patent Application Publication
(10) Pub. No.: US 2006/0024646 A1
(43) Pub. Date: Feb. 2, 2006

(54) System and audio product for instructing user in operating functions of motor vehicle

(75) Inventor: Michael Stahl, Landsberg am Lech (DE)

Correspondence Address: HOUSTON ELISEEVA, 4 MILITIA DRIVE, SUITE 4, LEXINGTON, MA, 02421, US

(73) Assignee: Pfriemer Kataloge GmbH, Munchen (DE)

(21) Appl. No.: 11/186,398

(22) Filed: Jul. 21, 2005

(30) Foreign Application Priority Data
Jul. 30, 2004 (DE) DE 10 2004 037 09

(51) Int. Cl. G09B 9/04; G09B 5/00

(52) U.S. Cl. 434/62; 434/308

(57) ABSTRACT

The invention relates to a system and an audio product for instructing a user in the operating functions of a motor vehicle. The invention features an audio file containing audio information for teaching the operating functions of a motor vehicle, and which may be brought into use on a player. By using the invention, a user of a motor vehicle may learn the operating functions of the motor vehicle simply and reliably by audio means.

### RELATED APPLICATIONS

This application claims priority to Germany Application No. DE 10 2004 037 090.7, filed on Jul. 30, 2004, which is incorporated herein by reference in its entirety.

### BACKGROUND OF THE INVENTION

Conventional manuals for operating functions of motor vehicles are provided in the form of printed operating instructions and quick-reference guides.

In the operating instructions, all information is clearly summarized and explained in detail as in a reference book. In the quick-reference guide, the most important items are clearly set out in brief in a leaflet. In addition to book form, these instructions are also available as a CD-ROM file. The user may display the information stored on the CD-ROM on a screen, or else print it out.

There are also interactive driving simulators for motor vehicles. The user is able carry out certain functions of a specific motor vehicle on a computer, as in a computer game, with the driver's area of the motor vehicle being shown on the screen in various driving situations. Such driving simulators are used on the one hand to give practice to new or student drivers. On the other hand, simple versions of driving simulators are also used as means of advertising, to enable potential customers to become familiar with a particular vehicle model.

The operating functions of motor vehicles are becoming increasingly extensive and complex due to the growing use of electronics. The printed operating instructions, now issued in book form, are correspondingly comprehensive and thus lengthy, with the books often containing more than 200 pages.

As a result, users do not make use of the operating instructions to the appropriate extent. There is therefore a considerable need to present the operating functions to drivers of new motor vehicles in a new way enables the users to receive instruction on the operating functions of their motor vehicle quickly and reliably.

DE 199 51 001 C2 shows a device for the display of information in a vehicle, in which the information may be presented both visibly and aurally. In particular this device has a display which can project data on to the windscreen. This display is described as a heads-up display, and has a projector installed in the instrument panel. With this display, information such as current speed, coolant temperature and fuel level are faded in directly. Other information such as a navigation device, tire pressure, a picture of the rear view from the vehicle, operating instructions, a user guide and a help assistant may also be faded in.

DE 199 07 795 A1 relates to a method for assisting a user of a motor vehicle in the operation of components. This method is intended to replace or supplement printed operating instructions. In this method a help inquiry element, for example in the form of a button, is actuated and thereafter any desired component of the vehicle is activated. The activated component is not operated, but instead the user is simply given information regarding the operating state which may be obtained with this actuating element in normal operation. This information may be provided by the spoken words.

DE 101 31 394 A1 describes a method for the transmission of software modules for target equipment on board a vehicle. The term “software module” describes programs or parts of programs that are run by onboard devices, and data for such programs or for equipment. “Target equipment” describes equipment onboard a vehicle, for which software modules are to be transmitted. This includes in particular data processing equipment. Such equipment may be adapted to particular users or circumstances through the acceptance of a new software module. This method also includes the transmission of audio and/or video data to the individual software modules, through which the operation of the particular target equipment is explained to the user. The playing of the audio and/or video data is started for example when required by the user, or when the transmission of the software modules has been successfully completed.

EP 1 079 392 A2 discloses a device for the recording and reproduction of digital audio signals for use in a motor vehicle. Using this device it should be possible to store several compact discs in a mass storage device, and then to listen to them in the vehicle as required. This is intended to avoid the carrying and replacement of compact discs in the vehicle, so that the driver is not distracted when driving the vehicle. The device may also be used to insert other compact discs, with data that may be displayed to the user on a display unit. These other compact discs may be e.g., operating instructions, a dictionary or the like.

### SUMMARY OF THE INVENTION

The present invention relates to a system and an audio product for instructing a user in the operating functions of a motor vehicle.

The invention is concerned with the challenge of overcoming or mitigating some or all of the disadvantages described above, and of providing a user with a new kind of instruction in the operating functions of a motor vehicle.

The problem is solved by a system for teaching the operating functions of a motor vehicle and an audio product.

The system according to the invention for instructing a user in the operating functions of a motor vehicle comprises: an audio file containing information for teaching the operating functions of a motor vehicle, and a player for playing the audio file.

According to the invention, the user of a motor vehicle is instructed in the operating functions of his motor vehicle by playing an audio file.

The user can listen to this audio file in his motor vehicle, which is very advantageous since all the elements that are being explained to him are in his immediate vicinity. If the motor vehicle is stationary, then the user can try out the individual operating functions as they are explained to him. The user may however also use the journey time to learn the operating functions of his motor vehicle.

The user thus has the opportunity to learn about operating functions more quickly and more conveniently, and to obtain background information, which would otherwise be only be derived after quite lengthy study of the comprehensive printed instructions.

The system according to the invention is of particular benefit to persons who are influenced by what they hear, and who absorb new information most easily by hearing it.

The invention thus contributes significantly to enhancing safety for the user, the vehicle driver, and other traffic users, since it is easier to convey to a user the vast amount of information relating to a new motor vehicle by audio means.

The audio file is preferably divided into several sections, with the user being able to select and play individual sections.

The individual sections contain, preferably at the beginning, a name of the section concerned so that, by means of a scanning function which is often provided on conventional players, the names of the individual sections may be presented to the user in consecutive order.

The first section of the several sections may contain a summary, so that the user is informed of the content of the complete audio file.

Most typically, the inventive method is used for teaching the operating functions of a motor vehicle to a purchaser of the vehicle. Specifically, a motor vehicle manufacturer provides, with the sale of its motor vehicle, an audio file, such as on a compact disc or other disc such as a DVD. The audio file comprises audio information for teaching the operating functions of the motor vehicle. The motor vehicle further has a player for playing the audio file. Thus, the purchaser of the motor vehicle plays the audio file in the player, and the audio file includes audio information that, when played in the player, generates audio signals to teach the operating functions of the motor vehicle to the purchaser.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a system according to the invention in schematic form, and

FIG. 2 shows the structure of an audio file of the system according to the invention in schematic form.

### DETAILED DESCRIPTION OF THE PREFERRED EMBODIMENTS

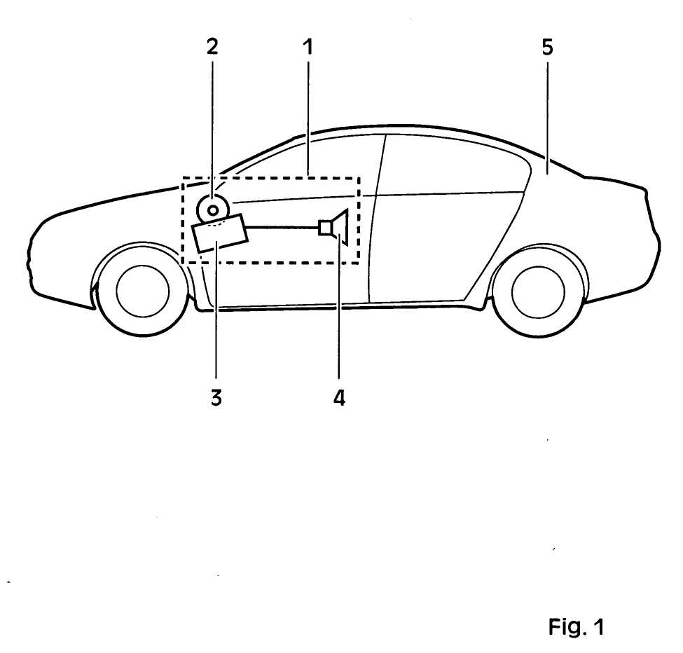

The system according to the invention for instructing a user in the operating functions of a motor vehicle is shown in schematic form in FIG. 1.

The system 1 comprises an audio file 2 which is shown in the form of a CD-ROM and contains audio information for instruction in the operating functions of a motor vehicle, and a player 3, shown in the form of a CD player, which is connected to a speaker 4. The speaker 4 converts the audio information into audio or sound signals.

The system is provided in a motor vehicle 5, in particular in a motorcar.

In the present embodiment, the audio file is stored on a machine-readable data storage medium, namely the compact disc (CD), as a digital audio file. The audio file may however also be transmitted to the player 3 via another data storage medium, such as e.g., a solid state memory (memory stick), other disc storage device (e.g. DVD), or over a data connection, e.g., the internet.

A breakdown of the audio information contained in the audio file 2 is given in Appendix 1 below. The audio information comprises several sections, listed as title 1 to title 31.

The section title 1 contains a welcome text, and the section title 2 contains a summary. The other titles are combined into groups, with the groups covering the operating elements in the driver's area, opening and closing, seating and stowing away, safety, driving tips, and notes on operation.

Appendix 2 gives the narrator's text manuscript for titles 1, 19 and 20.

The audio information is preferably structured according to the following pattern:

1. Firstly a welcome and introduction to the audio operating instructions according to the invention (title 1).

2. A spoken list of contents (title 2) giving the sections and the corresponding title numbers. Consequently the desired section may be selected using the title selector of the player or via the title number direct.

3. Each section begins by stating the name of the section or title concerned. Nowadays conventional CD players have a scan function which plays the start of each section consecutively. On running the scan function, the names of the individual sections are played in succession, so that the user is given a list of contents by audio means. When a specific name or title is given, the user may abort the scan function by actuating an appropriate key, and initiate the playing of the complete section.

4. Since each section begins by stating the relevant name of the section, if the player has a speech input or voice activated the user may select and play the desired section by speaking the relevant name.

5. Within the individual sections, first of all the position, symbols and functions of operating elements of the motor vehicle are explained, followed by a description of the relevant operating processes.

6. Following a section on a particular topic, there is preferably a further section with “tips and tricks” on this topic. Such “tips and tricks” are useful general background information which is not usually known, and which may easily be conveyed to a motor vehicle user by audio means. The imparting of this general background information represents a major benefit of the system according to the invention, since this background information can be presented in conventional printed operating instructions only as extensive text, which is generally not read by users. When driving the motor vehicle, on the other hand, the user has adequate time to listen to this general information, provided in an easily comprehensible manner.

Appendix 2 gives the narrator's text manuscript for the sections relating to the titles 14a “Air-conditioning” and 3a “Remote key.” These are followed respectively by the titles 14b “Tips on Air-conditioning” and 3b “Tips on the Remote Key,” containing relevant general background information on the use of such an automatic air-conditioning system or the remote key.

This type of information was previously often not read by the user, since it is not essential for using the motor vehicle. If followed, however, it makes use of the motor vehicle easier and more comfortable. An example of such information is that, in recirculation mode, one should never smoke, since the smoke would settle on the evaporator of the cooling system, resulting in odor nuisance for a long period of time (Appendix 2). Another important piece of information is that the used air is extracted through slits beneath the rear windows which must therefore not be blocked. Otherwise the power of the air-conditioning system will be reduced (Appendix 2). With regard to the remote key it is of interest that it stores the individual setting of the air-conditioning and, where applicable, the seat and mirror settings. If the vehicle is used by two people with different keys, then each person will find their individual settings provided on entering the vehicle (Appendix 2). There is a large quantity of such information, easily understood but immensely helpful in use of a motor vehicle, which is very seldom learned by the user of a motor vehicle from conventional operating instructions in book form. With the invention, this information may be presented to the user of a motor vehicle during the journey, when the user of the motor vehicle has time and leisure to become involved with his motor vehicle.

As may be recognized with the aid of Appendix 2, the text of the audio information does not correspond to that of conventional operating instructions. For example the choice of words is geared deliberately to colloquial speech, so that the text may be easily understood. Unnecessary technical terms are avoided. The information is presented in easily understandable units which may be absorbed even while traveling. There are pauses between the individual units, so that the concentration of the user is not too heavily stressed. Usually the pauses are greater than 2 or 3 seconds, or even 5 second or more, in length.

Each title of the “Tips” is divided into several examples from everyday driving experience. These are also known as “Infospots.” Each of these infospots deals with a situation-based case, with a complete small storyboard.

The situation-based cases are preferably explained using the model of a causal relationship (cause->event->effect). Recognition of the problem leads to the necessary action, which causes the effect. That is to say that first the cause or the corresponding problem is explained, then the event by which the problem is solved, and then the effect. This triggers a chain of reaction in the listener, on a mental and a practical level.

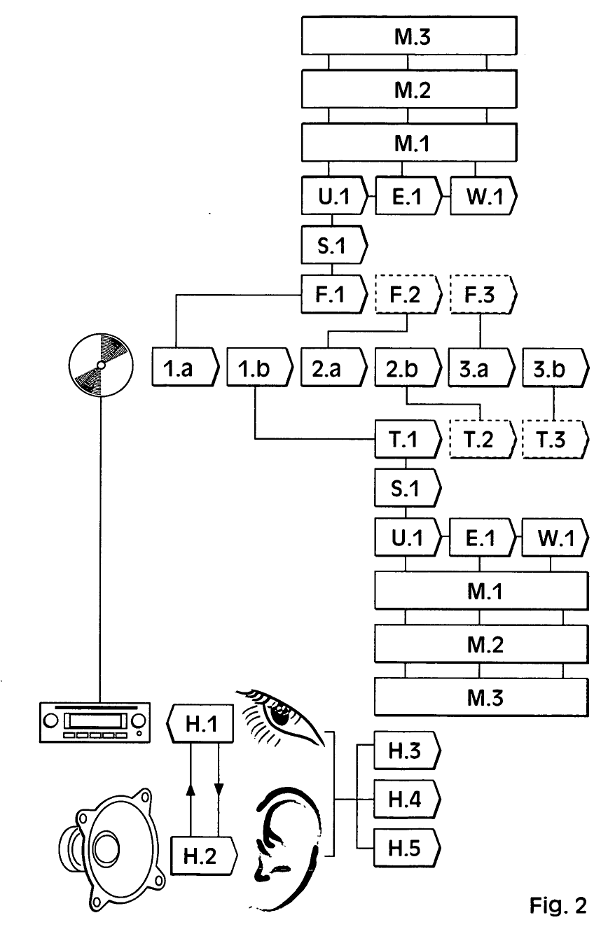

The situation-based cases and the causal relationships stimulate the imagination of the listeners, who are thereby able to visualize clear pictures in their minds (pictorial thinking—H.4 in FIG. 2).

When the infospots are heard in the vehicle, a visual transfer effect (H.1—seeing, and H.2—hearing) is achieved, since there is a direct relationship to the equipment in the vehicle. This leaves scope for imagination (H.5 in FIG. 2), since the contents are understood more rapidly (visual transfer effect).

In imparting the contents within an infospot, it is clearly seen that communication takes place using an author-based narrative model. A narrator and a narrative model using the work of an author is an epic method of presentation using the first or third person, with dominant “telling.” This means that the narrator engages in the action with comments, at the same time reflecting, evaluating, looking ahead, reverting back, and switching between external and internal views and where applicable between different narrative perspectives. Here the narrator using the work of the author knows the causes and describes the necessary actions which the listener must take in order to solve the problem. The intonation of the narrator's voice and the rhythm of speech assist the rapid memorizing of the information.

FIG. 2 shows in schematic form the structuring of the audio file. The titles to the function descriptions for topics 1, 2 and 3 are designated 1.A, 2.A and 3.A. The titles of the corresponding tips for topics 1, 2 and 3 are designated 1.B, 2.B and 3.B. Assigned to each title of the function descriptions 1.A, 2.A and 3.A is a corresponding function description F.1, F.2 and F.3. Preferably inserted in the individual function descriptions are situation-based cases, the storyboards, which are in turn explained, according to the causal relationship, by cause, event and effect. This is shown schematically in FIG. 2 for topic 1. Thus for example in Appendix 2, in the section on air-conditioning on page 6 in paragraph 1, the problem or situation is explained in which one would want to intervene in the automatic operation of an air-conditioning system (cause). Individual events are then explained, such as e.g., if something is controlled apart from the temperature itself, with its effect that the air-conditioning system switches to manual operation. In this connection, preferably the features of the visual transfer effect explained above, of the narrative model OSW, are realized; these are designated M.1, M.2 and M.3 in FIG. 2.

The same applies to the structure of the section on tips, which are designated T.1, T.2 and T.3, relating to topics 1, 2 and 3. In Appendix 2, in paragraph 1 under “Tips on the air-conditioning system,” there is an explanation of the situation in which the vehicle has stood for a long time in the sun (page 1) so that the interior has become hot (=problem: U.1). Now the work of the air-conditioning is made easier by the event or action of opening the window (E.1). The windows are then closed and the button for recirculation mode should be pressed. This results in more rapid cooling of the volume of air in the vehicle (W.1).

Preferably the text is set to music, with the music being louder in the pauses than during the speaking of the text. The rhythm of the text is designed so that the speech is correlated symbiotically with the music.

The text is spoken preferably by a woman, with a vocal range lying in the transition zone between alto and mezzo-soprano. This vocal frequency range is especially easy to understand against the background noise inside a motor vehicle. It has been found that lower vocal frequency ranges are more difficult to understand, while higher vocal frequency ranges sound unpleasant to some users.

Preferably different music is assigned to each section. For reasons of recognition, however, the sections on “tips” begin with the same music sequence.

The music is preferably so arranged that substantially only instruments are used which have a frequency range differing from that of the narrator's voice, so that ease of understanding is not impaired.

The spoken text may be read beforehand by a female narrator, and recorded. It is however also possible to generate the spoken text synthetically.

The invention may also be realized as an audio product, comprising a data storage medium on which the audio file 2 is stored, and which may be converted into audio signals on a player.

In the embodiment of the instruction system according to the invention described above, a conventional CD player installed in the motor vehicle becomes an information system teaching the user of a motor vehicle about the operating functions of a motor vehicle, through the insertion of a CD on which the audio file is stored. Although CD players in motor vehicle are designed for the playing of music CDs and radio play CDs, i.e. simply for the entertainment of the vehicle occupants, they are surprisingly excellent for use with the instruction system according to the invention, since individual sections may be selected and played by the user, to obtain on an individual basis information on specific aspects of his or her motor vehicle. The invention thus creates a completely new form of conveying instructions to the driver of a vehicle.

Instead of a CD player, another type of player, as for example an MP3 player or the like, may also be used. For the invention it is useful if the player has a function for selecting specific sections of the audio file, so that an individual selection may be made by the user.

The invention may be summarized briefly as follows:

The invention relates to a system and an audio product for teaching the operating functions of a motor vehicle.

The invention features an audio file containing audio information for teaching the operating functions of a motor vehicle, and which may be brought into use on a player.

By using the invention, a user of a motor vehicle may learn the operating functions of the motor vehicle simply and reliably by audio means.

Appendix 1 gives the breakdown of the content of an audio file of the system according to the invention, and
Appendix 2 comprises a narrator's text manuscript of individual specific sections of the audio file of the system according to the invention.

Appendices

Appendix 1 (Begin)

The Audio Operating Instructions

Summary

| | |
|---|---|
| Title 1 | Welcome |
| Title 2 | Contents |

Opening and Closing

| | |
|---|---|
| Title 3a | The remote key |
| Title 3b | Tips on the remote key |

Operating Elements in the Driver's Area

| | |
|---|---|
| Title 4a | Instruments and indicator lights |
| Title 4b | Tips on the instruments and indicator lights |
| Title 5a | Operating elements on the steering wheel |
| Title 5b | Tips on the operating elements on the steering wheel |
| Title 6a | Manual/automatic transmission |
| Title 6b | Tips on the manual/automatic transmission |
| Title 7a | Light switches, headlight leveling control |
| Title 7b | Tips on the lights |
| Title 8a | Operating elements in the centre console |
| Title 8b | Tips on the operating elements in the centre console |
| Title 9a | Onboard computer |
| Title 9b | Tips on the onboard computer |
| Title 10a | Park distance control |
| Title 10b | Tips on the park distance control |
| Title 11a | Proximity-controlled cruise control |
| Title 11b | Tips on the proximity-controlled cruise control |
| Title 12a | Air suspension and chassis programs |
| Title 12b | Tips on the air suspension and chassis programs |
| Title 13a | Radio Sound/Navigation System |
| Title 13b | Tips on the Radio Sound/Navigation System |
| Title 14a | Air-conditioning/Automatic climate control system |
| Title 14b | Tips on the air-conditioning/Automatic climate control system |
| Title 15a | Sliding/opening roof or convertible top |
| Title 15b | Tips on the sliding/opening roof or convertible top |

Correct Seating

Title 16A Seat, headrest, seat belt adjustment and seat memory

Title 16b Tips on seating

Safety

Title 17a Safety and safe driving

Title 17b Tips on safety

Driving in Formation

Title 18a Driving and the environment

Title 18b Tips on driving

Operating Instructions

Title 19 Operating instructions

Appendix 1 (End)

Appendix 2 (Begin)

The Audio Instructions

Narrator's Text Manuscript

Welcome

Naturally you wish to find your way around your new car as quickly as possible. That is why we have taken a new approach with this CD. In a quite relaxed, entertaining and vivid manner we shall explain to you the main operating functions of your car. This is followed by valuable background information on each topic.

However, this CD can not replace the detailed explanations and information in your operating instructions.

Enjoy listening! We wish you a safe journey at all times.

The Remote Key

You don't notice it straight away, but the key of your car is not just for starting the engine. It has more functions than you might expect. Here they are in order:

You can use the key to open and lock your car remotely. For this purpose there are three buttons on the front with clear symbols.

The opening button will open all doors, the luggage space and the tank filler flap. If the vehicle has central locking, then first of all only the driver's door and the tank filler flap are unlocked. Only after further pressing are the other doors and the luggage space unlocked too. If during the next 60 seconds you open none of the doors, then the vehicle will be locked again automatically for security reasons.

With the closing button you lock the vehicle. If your car has an alarm system, it will then be activated.

When you unlock the car, the indicator lights flash twice and the internal lights come on. On locking, the indicator lights flash briefly once, and the internal lights go out. If there are no signals, then a door or the luggage compartment is still open.

If you just want to unlock the luggage compartment, press for at least one second on the button with the luggage compartment symbol.

Tips on the Remote Key

Something you perhaps did not know: you can also use the remote key to open the windows or to close the windows and the sliding roof.

That can be a Real Help. Why?

You notice only after getting out of the car that a window or the sliding roof is still open. No problem. Simply press the close button until everything is shut as desired.

Or else, assume that your Audi is standing in the blazing sun on a hot day. Even from a distance, by longer pressing of the opening button you can open the windows to let fresh air into the vehicle.

Of course you can still open and lock your car using the door locks. But be careful. If your car is fitted with an alarm system, you must insert the key in the ignition switch not later than 15 seconds after opening the door. If you don't do this, then the alarm will be activated. If this should happen by mistake, just press the opening button.

Your Audi is fitted with protection against break-in.

This means that, with the vehicle locked, the doors and windows can no longer be opened from the inside. For this reason no-one—and especially children—should remain in the locked vehicle.

If this is unavoidable, you must deactivate the break-in protection. This is done by inserting the key in the door lock and turning it twice in quick succession in the locking direction.

The car alarm system is still activated. You should also switch off the interior monitoring, since otherwise any movement in the vehicle will trigger the alarm.

Your ignition key also has a small but powerful “memory.” When you remove it after a journey, it has stored your individual setting of the air-conditioning and also—if so equipped—your seat and mirror settings.

Next time you travel, all your comfort settings are provided once again quite automatically.

The same applies to the spare key.

With the set of keys for your Audi, you also receive a code label. Do not keep this in the car, since only with this code can you block a lost key or have a spare key made.

Another note on the car locking function:
for your safety your car is permanently locked at a speed of 15 km/h and above. Cancel this locking either with the door opening lever or the central locking switch.

And in an Emergency?

In the event of an accident, helpers can open your vehicle without difficulty, since the locking is cancelled immediately by the release of an airbag.

The Air-Conditioning System

You may think that the air-conditioning is mainly for comfort, to cool the car in summer and create a relaxed atmosphere for driving. That is of course true, but the air-conditioning system can do much more.

First of all, it is an additional safety feature. For not only does it control the temperature in the vehicle, it also dries the air and so prevents misting up of the windows. You therefore have the best possible view in all weather conditions.

You may choose between two modes of operation: automatic or manual.

In automatic mode the air-conditioning system automatically ensures that the chosen temperature is reached quickly and then held constant. This is quite simple: press the AUTO button. The button lights up. Now set the desired temperature. We recommend 22° C. at any time of the year.

The air-conditioning now ensures that the temperature remains at the set level. It does this by automatically controlling the fan power, the air volume and the air distribution depending on outside temperature and air humidity levels.

While the AUTO setting is very convenient, situations can arise in which you may wish to intervene in the automatic operation. Any time you adjust something yourself—apart from the temperature—the air-conditioning system switches to manual operation.

For example if you press the ECON button, the following occurs: the air-conditioning switches off and the system now operates only as cooling, otherwise as normal heating. It can no longer be cooler in the vehicle than outside.

Now the recirculation mode: with this setting you prevent fresh air from entering the vehicle. This is important if the air outside is anything but fresh. In a tunnel for example, in dense urban traffic, and at any time when exhaust fumes may enter the car. Smoke, unpleasant environmental odors and even pollen maybe excluded from the car.

If due to high air humidity in the car the windows start to mist up, then press the defrost button. The windows will then clear very quickly.

Pressing the AUTO button at any time will return you to automatic mode.

Tips on the Air-Conditioning System

Assume your vehicle has stood in the sun for a lengthy period and the interior has become very hot. Now you can make the work of the air-conditioning system easier. Open the windows for a short time to provide a draught. Then close the windows and press the recirculation button. Why? In recirculation mode, only the air actually inside the vehicle needs to be cooled down, and that of course happens more quickly.

The same applies when you want to get warm quickly. Switch on recirculation mode and the heating need only warm up the air which is actually in the vehicle.

Once the temperature is acceptable, select automatic mode again with the AUTO button. Really quite easy, isn't it?

Never smoke when recirculation mode is operating. The smoke would settle on the evaporator of the cooling system and the odor nuisance would then be present for a long time!

There may be quite simple reasons for a sudden loss of power in the air-conditioning system. Perhaps it is just not getting any air. Ensure that the air inlet in front of the windscreen is always free from ice, snow or leaves. The same applies to “breathing out.” The used air is extracted through slits beneath the rear windows. Obviously these must be kept free. So don't hang any items of clothing or other things over them.

By the way: if you have been traveling in hot, muggy conditions for some time and then park your car, you may soon notice a pool of water beneath the vehicle. Don't worry, everything is in order. It is just that condensation water has formed on the evaporator and is now dripping out.

Appendix 2 (End)

While this invention has been particularly shown and described with references to preferred embodiments thereof, it will be understood by those skilled in the art that various changes in form and details may be made therein without departing from the scope of the invention encompassed by the appended claims.

What is claimed is:

1. System for teaching the operating functions of a motor vehicle, comprising:
an audio file comprising audio information for teaching the operating functions of
a motor vehicle, and
a player for playing the audio file.

2. System according to claim 1, wherein the player is installed in the interior of a motor vehicle.

3. System according to claim 1, wherein the audio file is divided into several sections, and that the player is capable of being controlled by an operator to select and play any one of the sections.

4. System according to claim 3, wherein at the start of each section, the audio information comprises the name of the section concerned.

5. System according to claim 3, wherein one section of the several sections comprises audio information on the contents of the other sections.

6. System according claim 1, wherein the audio information is stored in the audio file in the form of a female voice.

7. System according claim 1, wherein the audio information comprises predetermined pauses.

8. System according claim 1, characterized in that the audio information is combined with music information.

9. System according to claim 8, characterized in that the rhythm of the audio information is correlated with the rhythm of the music information.

10. System according to claim 8, wherein a volume of the music information during pauses in the audio information is higher than during the playing of the audio information.

11. System according to claim 1, wherein the audio file is stored on a data storage medium.

12. Audio product for teaching the operating functions of a motor vehicle, comprising a data storage medium in which an audio file is stored, the audio file comprising audio information that, when played in a player, generates audio signals to teach the operating functions of the motor vehicle.

13. Audio product according to claim 12, wherein the audio file is divided into several sections.

14. Audio product according to claim 13, wherein at the start of each section, the audio information includes a name of the section concerned.

15. Audio product according to claim 13, wherein one section of the several sections includes audio information on the content of the other sections.

16. Audio product according to claim 12, wherein the audio information is stored in the audio file in the form of a female voice.

17. Audio product according to claim 12, wherein the audio information comprises predetermined pauses.

18. Audio product according to claim 12, wherein the audio information is combined with music information.

19. Audio product according to claim 18, wherein a rhythm of the audio information is correlated with a rhythm of the music information.

20. Audio product according to claim 18, wherein a volume of the music information in pauses in the audio information is higher than during the playing of the audio information.

21. A method for teaching the operating functions of a motor vehicle, comprising:
a motor vehicle manufacturer providing, with a motor vehicle, an audio file comprising audio information for teaching the operating functions of the motor vehicle, and
the motor vehicle having a player for playing the audio file;
a purchaser of the motor vehicle playing the audio file in the player; and
the audio file including audio information that, when played in the player, generates audio signals to teach the operating functions of the motor vehicle to the purchaser.
